(19) United States
(12) Patent Application Publication
(10) Pub. No.: US 2022/0266345 A1
(43) Pub. Date: Aug. 25, 2022

(54) POWER SUPPLY ASSEMBLY FOR ADDITIVE MANUFACTURING SYSTEM

(71) Applicant: Nikon Corporation, Tokyo (JP)

(72) Inventors: Joseph Paul Rossi, San Jose, CA (US); Yoon Jung Jeong, San Mateo, CA (US); Patrick Shih Chang, San Francisco, CA (US); Johnathan Agustin Marquez, San Francisco, CA (US); Alton Hugh Phillips, Oro Valley, AZ (US); Lexian Guo, Union City, CA (US)

(21) Appl. No.: 17/675,398

(22) Filed: Feb. 18, 2022

Related U.S. Application Data
(60) Provisional application No. 63/151,480, filed on Feb. 19, 2021.

(51) Int. Cl. B22F 12/50; B33Y 10/00; B33Y 30/00; B33Y 40/00; B22F 10/28

(52) U.S. Cl. CPC B22F 12/50; B33Y 10/00; B33Y 30/00; B33Y 40/00; B22F 10/28

(57) ABSTRACT

A processing machine (10) for building an object (11) from powder (12) includes a build platform (434A); a powder supply assembly (418); and an energy system (22) that melts the powder (12) on the build platform (434A) to form the object (11). The powder supply assembly (418) can include (i) a first container region (444A) that retains the powder (12) prior to distribution onto the build platform (434A); (ii) a supply outlet (439) positioned over the build platform (434A); (iii) a flow control assembly (442) that selectively controls the flow of the powder (12) from the first container region (444A) to the supply outlet (439); (iv) a second container region (446A) that retains the powder (12) for refilling the first container region (444A); and (v) an actuator system (448) that urges powder (12) from the second container region (446A) to fill the first container region (444A).

### RELATED APPLICATIONS

This application claims priority on U.S. Provisional Application No. 63/151,480 filed on Feb. 19, 2021, and entitled “POWDER SUPPLY ASSEMBLY FOR ADDITIVE MANUFACTURING”. As far as permitted the contents of U.S. Provisional Application No. 63/151,480 are incorporated in their entirety herein by reference.

As far as permitted the contents of PCT Application No: PCT/US2020/040498 entitled “POWDER SUPPLY ASSEMBLY FOR ADDITIVE MANUFACTURING” filed on Jul. 1, 2020 are incorporated herein by reference.

### BACKGROUND

Three-dimensional printing systems are used to print three-dimensional objects. Existing three-dimensional printing systems are relatively slow, have a low throughput, are expensive to operate, and/or generate excessive waste. There is a never ending search to increase the speed, the throughput and reduce the cost of operation for three-dimensional printing systems. For example, there is a never ending search to improve how the material used for the three-dimensional printing is delivered to the system.

### SUMMARY

The present implementation is directed to a processing machine for building a three-dimensional object from powder. The processing machine can include a build platform; a powder supply assembly that deposits the powder onto the build platform to form a powder layer; and an energy system that directs an energy beam at a portion of the powder on the build platform to form a portion of the object. The powder supply assembly can include (i) a first container region that retains the powder prior to distribution onto the build platform; (ii) a supply outlet positioned over the build platform; (iii) a flow control assembly that selectively controls the flow of the powder from the first container region to the supply outlet; (iv) a second container region that retains the powder for refilling the first container region; and (v) an actuator system that urges powder from the second container region to fill the first container region.

A number of different powder supply assemblies are disclosed herein. As an overview, these powder supply assemblies are uniquely designed to accurately, efficiently, evenly, and quickly distribute the powder onto the build platform. This will improve the accuracy of the built object, and reduce the time required to form the built object.

In one implementation, the second container region can include a refill outlet that is positioned above the first container region. Further, the actuator system can include a movable part and a part mover assembly that selectively moves the movable part relative to the second container region to urge the powder from the refill outlet. Additionally, the second container region can include a plurality of spaced apart fins that are positioned in the refill outlet. Moreover, the plurality of fins can include a first fin and a second fin that is positioned above the first fin. In this design, the second fin extends farther over the first container region than the first fin. Further, the part mover assembly can move the movable part relative to the second container region along a movement axis, and the plurality of fins can be oriented substantially parallel to the movement axis.

Additionally, or alternatively, the flow control assembly can include a flow structure having a plurality of flow apertures that extend through the flow structure. In this design, at least one of the flow apertures has an aperture size that is larger than a nominal particle size of the powder particles. Further, the flow structure can allow powder to flow therethrough upon sufficient vibration of the first container region. Moreover, the flow control assembly can include a vibration generator that is secured to the first container region.

Additionally, or alternatively, the processing machine can include a mover that rotates at least one of the build platform and the powder supply assembly about a rotation axis while the powder supply assembly deposits the powder onto the build platform.

In another implementation, the processing machine again includes the build platform; the powder supply assembly that distributes the powder onto the build platform; and the energy system that directs an energy beam at a portion of the powder on the build platform to form a portion of the object. In this implementation, the powder supply assembly includes a powder container that retains the powder; a supply outlet positioned over the build platform; and a flow control assembly that selectively controls the flow of the powder from the supply outlet. For example, the flow control assembly can include (i) a flow structure having at least one structure surface feature, (ii) a flow guide that is urged against the flow structure, and (iii) a structure mover that moves the flow structure relative to the flow guide to release the powder from the at least one structure surface feature to the supply outlet.

The flow structure can be shaft shaped and the flow structure can include a plurality of spaced apart structure surface features. Additionally, or alternatively, the structure mover can rotate the flow structure to release the powder to the supply outlet.

At least one of the structure surface features have a feature size that is larger than a nominal powder particle size. Typically, each of the structure surface features has a feature size that is larger than a nominal powder particle size.

In certain designs, gravity urges the powder in the powder container against the flow control assembly.

The flow guide can be a resilient plate. Additionally, or alternatively, the flow structure can be a mill-shaped shaft.

Additionally, or alternatively, the processing machine can include a mover that rotates at least one of the build platform and the powder supply assembly about a rotation axis while the powder supply assembly deposits the powder onto the build platform.

In another implementation, the present invention is directed to a method for building a three-dimensional object from powder that includes: providing a build platform; distributing powder onto the build platform with a powder supply assembly that includes (i) a first container region that retains the powder prior to distribution onto the build platform; (ii) a supply outlet positioned over the build platform; (iii) a flow control assembly that selectively controls the flow of the powder from the first container region to the supply outlet; (iv) a second container region that retains the powder for refilling the first container region; and (v) an actuator system that urges powder from the second container region to fill the first container region; and directing an energy beam at a portion of the powder on the build platform to form a portion of the object.

In still another implementation, the present invention is directed to a method for building a three-dimensional object from powder that includes: providing a build platform; distributing powder onto the build platform with a powder supply assembly that includes a powder container that retains the powder; a supply outlet positioned over the build platform; and a flow control assembly that selectively controls the flow of the powder from the supply outlet, the flow control assembly including (i) a flow structure having at least one structure surface feature, (ii) a flow guide that is urged against the flow structure, and (iii) a structure mover that moves the flow structure relative to the flow guide to release the powder from the at least one structure surface feature to the supply outlet; and directing an energy beam at a portion of the powder on the build platform to form a portion of the object.

### BRIEF DESCRIPTION OF THE DRAWINGS

The novel features of this embodiment, as well as the embodiment itself, both as to its structure and its operation, will be best understood from the accompanying drawings, taken in conjunction with the accompanying description, in which similar reference characters refer to similar parts, and in which:

FIG. 1A is a simplified side view of an implementation of a processing machine;

FIG. 1B is a simplified top view of a portion of the processing machine of FIG. 1A;

FIG. 2 is a simplified top view of a portion of another implementation of the processing machine;

FIG. 3 is a simplified top view of a portion of still another implementation of the processing machine;

FIG. 4A is a simplified perspective view of a portion of still another implementation of the processing machine;

FIG. 4B is a cut-away view taken on line 4B-4B in FIG. 4A;

FIG. 4C is a cut-away view of a first container subassembly when there is no powder flow;

FIG. 4D is a cut-away view taken from line 4D-4D in FIG. 4A, without the powder;

FIG. 4E is a simplified top view of the first container subassembly;

FIG. 4F is a top view of one implementation of a flow controller;

FIG. 4G is a side view a flow structure;

FIG. 5 is a simplified cut-away view of a portion of a second container subassembly;

FIG. 6 is a simplified cut-away view of a portion of another, second container subassembly;

FIG. 7A is a perspective view of another implementation of a power supply assembly;

FIG. 7B is a cut-away view taken on line 7B-7B in FIG. 7A;

FIG. 7C is an enlarged view of FIG. 7B with a portion of a build platform;

FIG. 7D is a perspective view of a flow structure from FIG. 7A; and

FIG. 8 is a simplified side illustration of a portion of yet another implementation of the processing machine.

### DESCRIPTION

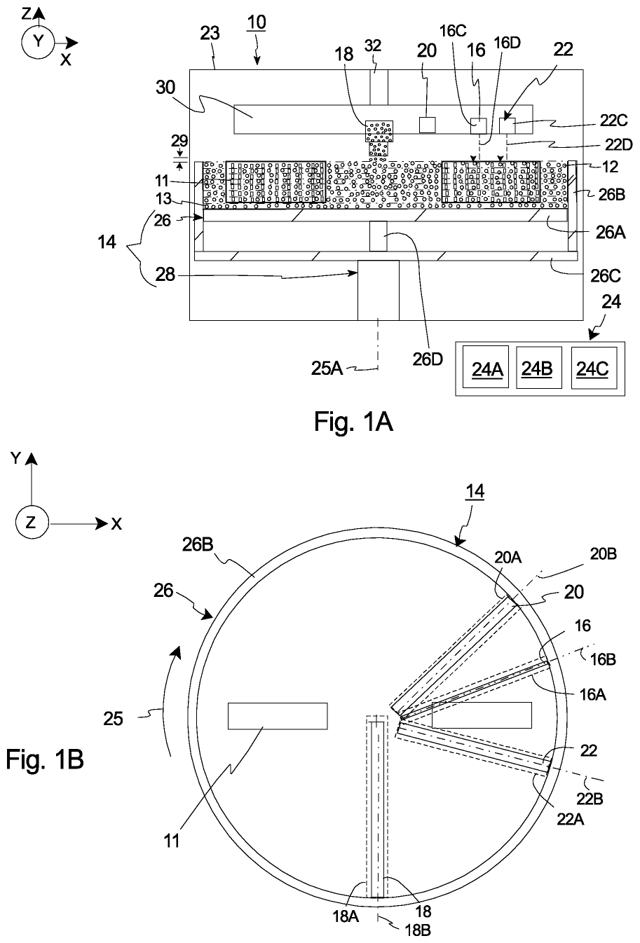

FIG. 1A is a simplified schematic side illustration of a processing machine 10 that may be used to manufacture one or more three-dimensional objects 11 (each illustrated as box). As provided herein, the processing machine 10 can be an additive manufacturing system, e.g. a three-dimensional printer, in which powder 12 (illustrated as small circles) in a series of powder layers 13 (illustrated as dashed horizontal lines) is joined, melted, solidified, and/or fused together to manufacture one or more three-dimensional object(s) 11 (two are illustrated). In FIG. 1A, each of the objects 11 includes a plurality of small squares that represent the joining of the powder 12 to form the object 11.

The type of three-dimensional object(s) 11 manufactured with the processing machine 10 may have various shapes or geometries. As a non-exclusive example, the three-dimensional object 11 may be a metal part, or another type of part, for example, a resin, plastic, or a ceramic part, etc. The three-dimensional object 11 may also be referred to as a “built part”.

The type of powder 12 joined and/or fused together may be varied to suit the desired properties of the object(s) 11. As a non-exclusive example, the powder 12 may include metal powder grains (e.g., including one or more of titanium, aluminum, vanadium, chromium, copper, stainless steel, or other suitable metals) or alloys for metal three-dimensional printing. Alternatively, the powder 12 may be non-metal powder, plastic, polymer, glass, ceramic powder, organic powder, inorganic powder, or any other material known to people skilled in the art. The powder 12 may also be referred to as “material” or “powder particles”.

A number of different designs of the processing machine 10 are provided herein. In certain implementations, the processing machine 10 includes (i) a powder bed assembly 14; (ii) a pre-heat device 16; (iii) a powder supply assembly 18 (illustrated as a box); (iii) a measurement device 20 (illustrated as a box); (iv) an energy system 22 (illustrated as a box); and (v) a control system 24 (illustrated as a box) that cooperate to make each three-dimensional object 11. The design of each of these components may be varied pursuant to the teachings provided herein. Further, the positions of the components of the processing machine 10 may be different than that illustrated in FIG. 1. Moreover, the processing machine 10 can include more components or fewer components than illustrated in FIG. 1A. For example, the processing machine 10 can include a cooling device (not shown in FIG. 1A) that uses radiation, conduction, and/or convection to cool the powder 12. Alternatively, for example, the processing machine 10 can be designed without the pre-heat device 16 and/or the measurement device 20.

A number of different powder supply assemblies 18 are disclosed herein. As an overview, these powder supply assemblies 18 are uniquely designed to accurately, uniformly, efficiently, evenly, and quickly distribute the powder layers 13 onto the powder bed assembly 14. Further, in certain implementations, the powder supply assembly 18 distributes the powder 12 over a relatively large powder bed assembly 14. This will improve the accuracy of the built object 11, and reduce the time required to form the built object 11.

The thickness of each powder layer 13 can be varied to suit the manufacturing requirements. In alternative, non-exclusive examples, one or more (e.g. all) of the powder layers 13 can have a uniform layer thickness (along the Z axis) of approximately twenty, thirty, forty, fifty, sixty, seventy, eighty, or ninety, or one hundred microns. However other layer thicknesses are possible. Particle sizes of the powder 12 can be varied. In one implementation, a common particle size is approximately fifty microns. Alternatively, in other non-exclusive examples, the particle size can be approximately twenty, thirty, forty, sixty, seventy, eighty, or ninety, or one hundred microns. However other powder particle sizes are possible.

A number of Figures include an orientation system that illustrates an X axis, a Y axis that is orthogonal to the X axis, and a Z axis that is orthogonal to the X and Y axes. It should be noted that any of these axes can also be referred to as the first, second, and/or third axes. Further, as used herein, movement with six degrees of freedom shall mean along and about the X, Y, and Z axes.

In FIG. 1A, a portion of the powder bed assembly 14 is illustrated in cut-away so that the powder 12, the powder layers 13 and the object 11 are visible. With the present design, one or more objects 11 can be simultaneously made with the processing machine 10.

It should be noted that any of the processing machines 10 described herein may be operated in a controlled environment, e.g. such as a vacuum, using an environmental chamber 23 (illustrated in FIG. 1A as a box). For example, one or more of the components of the processing machine 10 can be positioned entirely or partly within the environmental chamber 23. Alternatively, at least a portion of one or more of the components of the processing machine 10 may be positioned outside the environmental chamber 23. Still alternatively, the processing machine 10 may be operated in non-vacuum environment such as inert gas (e.g., nitrogen gas or argon gas) environment.

FIG. 1B is a simplified top view of a portion of the powder bed assembly 14 of FIG. 1A and the three-dimensional objects 11. FIG. 1B also illustrates (i) the pre-heat device 16 (illustrated as box) and a pre-heat zone 16A (illustrated with dashed lines) which represents the approximate area in which the powder 12 can be pre-heated with the pre-heat device 16; (ii) the powder supply assembly 18 (illustrated as a box) and a deposit zone 18A (illustrated in phantom) which represents the approximate area in which the powder 12 can be added and/or spread to the powder bed assembly 14 by the powder supply assembly 18; (iii) the measurement device 20 (illustrated as a box) and a measurement zone 20A (illustrated in phantom) which represents the approximate area in which the powder 12 and/or the object 11 can be measured by the measurement device 20; and (iv) the energy system 22 (illustrated as a box) and an energy zone 22A which represents the approximate area in which the powder 12 can be melted and fused together by the energy system 22.

It should be noted that these zones may be spaced apart different, oriented differently, or positioned differently from the non-exclusive example illustrated in FIG. 1B. Additionally, the relative sizes of the zones 16A, 18A, 20A, 22A may be different than what is illustrated in FIG. 1B.

In FIGS. 1A and 1B, in certain implementations, the processing machine 10 can be operated so that there is substantially constant relative motion along a moving direction 25 (illustrated by an arrow) between the object(s) 11 being formed and one or more of the pre-heat device 16, the powder supply assembly 18, the measurement device 20, and the energy system 22. The moving direction 25 may include a rotation direction about a rotation axis 25A. With this design, the powder 12 may be deposited and fused relatively quickly. This allows for the faster forming of the object(s) 11, increased throughput of the processing machine 10, and reduced cost for the object(s) 11.

In the implementation illustrated in FIG. 1A and 1B, the powder bed assembly 14 includes (i) a powder bed 26 that supports the powder 12 and the object(s) 11 while being formed, and (ii) a device mover 28 (e.g. one or more actuators) that selectively moves the powder bed 26. In this non-exclusive implementation, the powder bed 26 includes a build platform 26A, a support side wall 26B that extends upward around a perimeter of the support surface 26A, a support base 26C that supports the support side wall 26B, and a platform mover 26D. In this implementation, the build platform 26A can be moved linearly downward as each subsequent powder layer 12 is added relative to the support side wall 26B with the platform mover 26D (e.g. a linear motor, a fine pitch thread, or other actuator). Stated in another fashion, the build platform 26A can be moved somewhat similar to a piston relative to the support side wall 26B which act like as the piston's cylinder wall.

In alternative, non-exclusive implementations, the build platform 26A can be (i) flat, circular disk shaped for use with a corresponding support side wall 26B that is circular tube shaped; (ii) flat rectangular shaped for use with a corresponding support side wall 26B that is rectangular tube shaped, or (iii) polygonal-shaped for use with a corresponding support side wall 26B that is polygonal tube shaped. Alternatively, other shapes of the build platform 26A and the support side wall 26B may be utilized. Still alternatively, in another implementation, the support side wall 26B can be built concurrently as a custom shape around the object 11, while the object 11 is being built.

The device mover 28 can move the powder bed 26 relative to the pre-heat device 16 (and the pre-heat zone 16A), the powder supply assembly 18 (and the deposit zone 18A), the measurement device 20 (and the measurement zone 20A), and the energy system 22 (and the irradiation zone 22A). This allows nearly all of the rest of the components of the processing machine 10 to be fixed while the powder bed 26 is moved. For example, the device mover 28 can rotate the powder bed 26 about the rotation axis 25A relative to the pre-heat device 16, the powder supply assembly 18, the measurement device 20, and the energy system 22.

In one implementation, the device mover 28 can move the powder bed 26 at a substantially constant or variable angular velocity about the rotation axis 25A. As alternative, non-exclusive examples, the device mover 28 may move the powder bed 26 at a substantially constant angular velocity of at least approximately 1, 2, 5, 10, 20, 30, 60, 100 or more revolutions per minute (RPM). Stated in a different fashion, the device mover 28 may move the powder bed 26 at a substantially constant angular velocity of between one and one hundred revolutions per minute. As used herein, the term “substantially constant angular velocity” shall mean a velocity that varies less than 10% over time. In one embodiment, the term “substantially constant angular velocity” shall mean a velocity that varies less 0.2% from the target velocity. The device mover 28 may also be referred to as a “drive device”.

Additionally or alternatively, the device mover 28 may move the powder bed 26 in a stepped or other fashion. For example, it may be desired to speed up or slow down the rotation of the powder bed 26 for some sections, either as part of a normal cycle like increase time under pre-heater, or as a smart corrective action during the build (e.g. to repair a defect). The rotation axis 25A may be aligned along with gravity direction, and may be along with an inclination direction about the gravity direction. Still alternatively, the device mover 28 can be designed to move the powder bed 26 linearly along the Y and/or X axis.

In FIG. 1A, the device mover 28 can include one or more rotary motors or other type of actuator.

The powder 12 used to make the object 11 is deposited onto the powder bed 26 in a series of powder layers 13. Depending upon the design of the processing machine 10, the powder bed 26 with the powder 12 may be very heavy. With the present design, this large mass may be rotated at a constant or substantially constant speed to avoid accelerations and decelerations, and the required motion is a continuous rotation of a large mass, with no non-centripetal acceleration other than at the beginning and end of the entire exposure process. The melting process may be performed during the period when moving velocity is constant.

The pre-heat device 16 selectively preheats the powder 12 in the pre-heat zone 16A that has been deposited on the powder bed 26 during a pre-heat time. In certain embodiments, the pre-heat device 16 heats the powder 12 to a desired preheated temperature in the pre-heat zone 16A when the powder 12 is moved through the pre-heat zone 16A. The number of the pre-heat devices 16 may be one or plural.

In one embodiment, the pre-heat device 16 is positioned along a pre-heat axis (direction) 16B and is arranged between the measurement device 20 and the energy system 22. However, the pre-heat device 16 can be positioned at another location.

The design of the pre-heat device 16 and the desired preheated temperature may be varied. In one embodiment, the pre-heat device 16 may include one or more pre-heat energy source(s) 16C that direct one or more pre-heat beam(s) 16D at the powder 12. Each pre-heat beam 16D may be steered as necessary. As alternative, non-exclusives examples, each pre-heat energy source 16C may be an electron beam system, a mercury lamp, an infrared laser, a supply of heated air, thermal radiation system, a visual wavelength optical system or a microwave optical system. The desired preheated temperature may be 50% 75% 90% or 95% of the melting temperature of the powder material used in the printing. It is understood that different powders have different melting points and therefore different desired pre-heating points. As non-exclusive examples, the desired preheated temperature may be at least 300, 500, 700, 900, or 1000 degrees Celsius. Energy input may also vary dependent on melt duty of previous layers, specific regions on a layer, or progress though the build.

The powder supply assembly 18 deposits the powder 12 onto the powder bed 26. In certain embodiments, the powder supply assembly 18 supplies the powder 12 to the powder bed 26 in the deposit zone 18A while the powder bed 26 is being moved to form each powder layer 13 on the powder bed 26.

In one implementation, the powder supply assembly 18 extends along a powder supply axis (direction) 18B and is arranged between the measurement device 20 and the energy system 22. The number of the powder supply assemblies 18 may be one or plural.

With the present design, the powder supply assembly 18 deposits the powder 12 onto the powder bed assembly 14 to sequentially form each powder layer 13. Once a portion of the powder layer 13 has been melted with the energy system 22, the powder supply assembly 18 evenly and uniformly deposits another (subsequent) powder layer 13.

It should be noted that each three-dimensional object 11 is formed through consecutive fusions of consecutively formed cross sections of powder 12 in one or more powder layers 13. For simplicity, the example of FIG. 1A illustrates only a few, separate, stacked powder layers 13. However, it should be noted that depending upon the design of the object 11, the building process will require numerous powder layers 13.

A number of alternative powder supply assemblies 18 are described in more detail below. In these embodiments, the powder supply assembly 18 is an overhead powder supply that supplies the powder 12 onto the top of the powder bed assembly 14.

The measurement device 20 inspects and monitors the melted (fused) layers of the object 11 as that are being built, and/or the deposition of the powder layers 13. The number of the measurement devices 20 may be one or plural. For example, the measurement device 20 can measure both before and after the powder 12 is distributed.

As non-exclusive examples, the measurement device 20 may include one or more optical elements such as a uniform illumination device, fringe illumination device (structured illumination device), cameras that function at one or more wavelengths, lens, interferometer, or photodetector, or a non-optical measurement device such as an ultrasonic, eddy current, or capacitive sensor.

In one implementation, the measurement device 20 extends along a measurement axis 20B and is arranged between the powder supply assembly 18 and the pre-heat device 16, however, the measurement device 20 may be alternatively located.

The energy system 22 selectively heats and melts the powder 12 in the energy zone 22A to sequentially form each of the layers of the object 11 while the powder bed 26 and the object 11 are being moved. The energy system 22 can selectively heat the powder 12 at least based on a data regarding to the object 11 to be built. The data may be corresponding to a computer-aided design (CAD) model data. The number of the energy systems 22 may be one or plural.

In one embodiment, the energy system 22 is positioned along an energy axis (direction) 22B and is arranged between the pre-heat device 16 and the powder supply assembly 18. The design of the energy system 22 can be varied. In one embodiment, the energy system 22 may include one or more energy source(s) 22C (“irradiation systems”) that direct one or more irradiation (energy) beam(s) 22D at the powder 12. The one or more energy sources 22C can be controlled to steer the energy beam(s) 22D to melt the powder 12.

As alternative, non-exclusives examples, each of the energy sources 22C can be designed to include one or more of the following: (i) an electron beam generator that generates a charged particle electron beam; (ii) an irradiation system that generates an irradiation beam; (iii) an infrared laser that generates an infrared beam; (iv) a mercury lamp; (v) a thermal radiation system; (vi) a visual wavelength system; (vii) a microwave wavelength system; or (viii) an ion beam system.

Different powders 12 have different melting points. As non-exclusive examples, the desired melting temperature may be at least 1000, 1400, 1700, 2000, or more degrees Celsius.

The control system 24 controls the components of the processing machine 10 to build the three-dimensional object 11 from the computer-aided design (CAD) model by successively melting portions of one or more of the powder layers 13. For example, the control system 24 can control (i) the powder bed assembly 14; (ii) the pre-heat device 16; (iii) the powder supply assembly 18; (iii) the measurement device 20; and (iv) the energy system 22. The control system 24 can be a distributed system.

The control system 24 may include, for example, a CPU (Central Processing Unit) 24A, a GPU (Graphics Processing Unit) 24B, and electronic memory 24C. The control system 24 functions as a device that controls the operation of the processing machine 10 by the CPU executing the computer program. This computer program is a computer program for causing the control system 24 (for example, a CPU) to perform an operation to be described later to be performed by the control system 24 (that is, to execute it). That is, this computer program is a computer program for making the control system 24 function so that the processing machine 10 will perform the operation to be described later. A computer program executed by the CPU may be recorded in a memory (that is, a recording medium) included in the control system 24, or an arbitrary storage medium built in the control system 24 or externally attachable to the control system 24, for example, a hard disk or a semiconductor memory. Alternatively, the CPU may download a computer program to be executed from a device external to the control system 24 via the network interface. Further, the control system 24 may not be disposed inside the processing machine 10, and may be arranged as a server or the like outside the processing machine 10, for example. In this case, the control system 24 and the processing machine 10 may be connected via a communication line such as a wired communications line (cable communications), a wireless communications line, or a network. In case of physically connecting with wired, it is possible to use serial connection or parallel connection of IEEE1394, RS-232x, RS-422, RS-423, RS-485, USB, etc. or 10BASE-T, 100BASE-TX, 1000BASE- T or the like via a network. Further, when connecting using radio, radio waves such as IEEE 802.1x, OFDM, or the like, radio waves such as Bluetooth (registered trademark), infrared rays, optical communication, and the like may be used. In this case, the control system 24 and the processing machine 10 may be configured to be able to transmit and receive various types of information via a communication line or a network. Further, the control system 24 may be capable of transmitting information such as commands and control parameters to the processing machine 10 via the communication line and the network. The processing machine 10 may include a receiving device (receiver) that receives information such as commands and control parameters from the control system 24 via the communication line or the network. As a recording medium for recording the computer program executed by the CPU, a CD-ROM, a CD-R, a CD-RW, a flexible disk, an MO, a DVD-ROM, a DVD-RAM, a DVD-R, a DVD+R, a DVD-RW, a magnetic medium such as a magnetic disk and a magnetic tape such as DVD+RW and Blu-ray (registered trademark), a semiconductor memory such as an optical disk, a magneto-optical disk, a USB memory, or the like, and a medium capable of storing other programs. In addition to the program stored in the recording medium and distributed, the program includes a form distributed by downloading through a network line such as the Internet. Further, the recording medium includes a device capable of recording a program, for example, a general-purpose or dedicated device mounted in a state in which the program can be executed in the form of software, firmware or the like. Furthermore, each processing and function included in the program may be executed by program software that can be executed by a computer, or processing of each part may be executed by hardware such as a predetermined gate array (FPGA, ASIC) or program software, and a partial hardware module that realizes a part of hardware elements may be implemented in a mixed form.

It should also be noted that with the unique designs provided herein, multiple operations may be performed at the same time (simultaneously) to improve the throughput of the processing machine 10. Stated in another fashion, one or more of (i) pre-heating with the pre-heat device 16, (ii) measuring with the measurement device 20, (iii) depositing powder 12 with the powder supply assembly 18, and (iv) melting the powder with the energy system 22 may be partly or fully overlapping in time on different parts of the powder bed 26 to improve the throughput of the processing machine 10. For example, two, three, four, or all five of these functions may be partly or fully overlapping.

In certain implementations, the build platform 26A may be moved down with the platform mover 26D along the rotation axis 25A in a continuous rate. With this design, a height 29 between the most recent (top) powder layer 13 and the powder supply assembly 18 (and other components) may be maintained substantially constant for the entire process. Alternatively, the powder bed 26 may be moved down in a step down fashion at each rotation, which could lead to the possibility of a discontinuity at one radial position in the powder bed 26. As used herein, “substantially constant” shall mean the height 29 varies by less than a factor of three, since the typical thickness of each powder layer is less than one millimeter. In another embodiment, “substantially constant” shall mean the height 29 varies less than ten percent of the height 29 during the manufacturing process.

In one implementation, only the powder bed 26 is primarily moved, while everything else (pre-heat device 16, powder supply assembly 18, measurement device 20, energy system 22) are all fixed, making the overall system simpler. Also, the throughput of a rotary based powder bed 26 system is much higher since one or more steps can be performed in parallel rather than serially.

Additionally, or alternatively, the processing machine 10 can include a component housing 30 that retains the pre-heat device 16, the powder depositor 18, the measurement device 20, and the energy system 22. Collectively these components may be referred to as the top assembly. Further, the processing machine 10 can include a housing mover 32 that can be controlled to selectively move the top assembly. The housing mover 32 and/or the device mover 28 can include one or more actuators (e.g. linear or rotary). The housing mover 32 and/or the device mover 28 may be referred to as a first mover or a second mover.

It should be noted that processing machine 10 can be designed to have one or more of the following features: (i) one or more of the pre-heat device 16, the powder supply assembly 18, the measurement device 20, and the energy system 22 can be selectively moved relative to the component housing 30 and/or the powder bed 26 in one or more of the six degrees of freedom; (ii) the component housing 30 with one or more of the pre-heat device 16, the powder supply assembly 18, the measurement device 20, and the energy system 22 can be selectively moved relative to the powder bed 26 in one or more of the six degrees of freedom; and/or (iii) the powder bed 26 can be selectively moved relative to the component housing 30 in one or more of the six degrees of freedom.

In a specific, alternative implementation, the housing mover 32 can move the top assembly (or a portion thereof) upward (e.g. along and/or transverse to the rotation axis 25A) relative to the powder bed 26 at a continuous (or stepped) rate while the powder 12 is being deposited to maintain the desired height 29.

Additionally, or alternatively, the housing mover 32 can rotate the top assembly (or a portion thereof) relative to the powder bed 26 about the rotation axis 25A relative to the powder bed 26 during the printing of the object 11. In this implementation, the powder bed 26 can be stationary, rotated about the rotation axis in the clockwise direction, rotated about the rotation axis in the counterclockwise direction, and/or or moved linearly along and/or transverse to the rotation axis 25A.

Stated in another fashion, the processing machine 10 illustrated in FIGS. 1A and 1B may be designed so that (i) the powder bed 26 is rotated about the Z axis and moved along the rotation axis 25A; or (ii) the powder bed 26 is rotated about the rotation axis 25A, and the component housing 30 and the top assembly are moved along the rotation axis 25A only to maintain the desired height 29. In certain embodiments, it may make sense to assign movement along the rotation axis 25A to one component and rotation about the rotation axis 25A to the other.

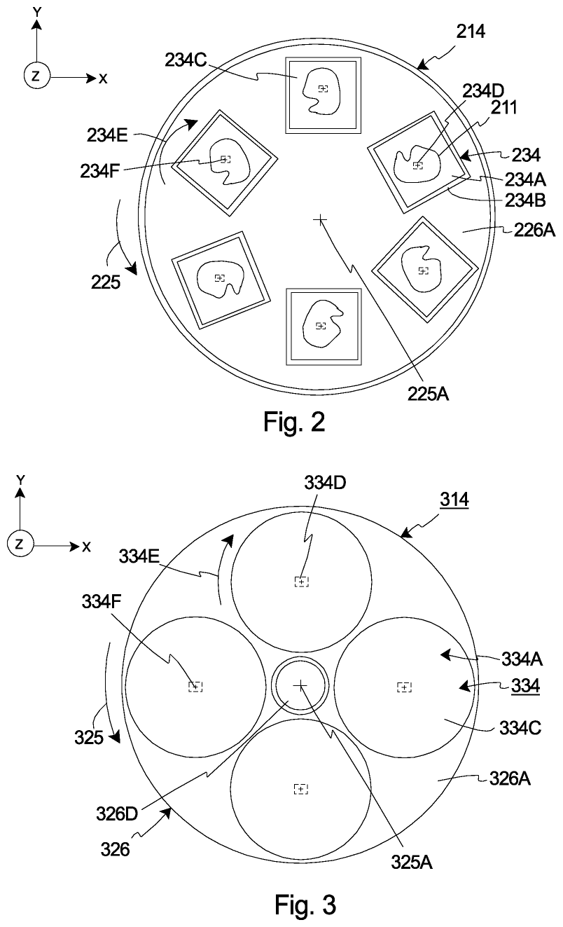

FIG. 2 is a simplified top illustration of another implementation of the powder bed assembly 214 that can be used in any of the processing machines 10 disclosed herein. In this embodiment, the powder bed assembly 214 can be used to make multiple objects 211 substantially simultaneously. The number of objects 211 that may be made concurrently can vary according the type of object 211 and the design of the processing machine 10. In FIG. 2, six objects 211 are made simultaneously. Alternatively, more than six or fewer than six objects 211 may be made simultaneously.

In FIG. 2, each of the objects 211 is the same design. Alternatively, for example, the processing machine 10 may be controlled so that one or more different types of objects 211 are made simultaneously.

In FIG. 2, the powder bed assembly 214 includes a relatively large support platform 226A, and a plurality of separate, spaced apart, build assemblies 234 that are positioned on and supported by the support platform 226A. The number of separate build assemblies 234 can be varied. In FIG. 2, the powder bed assembly 214 includes six separate build assemblies 214, one for each object 211. With this design, a single object 211 is made in each build assembly 234. Alternatively, more than one object 211 may be built in each build assembly 234. Still alternatively, the powder bed assembly 214 can include more than six or fewer than six separate build assemblies 234.

In one, non-exclusive embodiment, the support platform 226A with the build assemblies 234 can be rotated like a turntable during printing of the objects 211 in a moving direction 225 about a support rotation axis 225A (illustrated with a “+”, e.g. the Z axis). With this design, each build assembly 234 is rotated about at least one axis 225A during the build process. Further, in this embodiment, the separate build assemblies 234 are spaced apart on the large common support platform 226A. The build assemblies 234 can be positioned on or embedded into the support platform 226A. As non-exclusive examples, the support platform 226A can be disk shaped or rectangular shaped.

As provided herein, each of the build assemblies 234 defines a separate, discrete build region. For example, each build assembly 234 can include a build platform 234A, and a sidewall assembly 234B. In one embodiment, each build assembly 234 is an open container in which the object 211 can be built. In this design, after the object 211 is printed, the build assembly 234 with the printed object 211 can be removed from the support platform 226A via a robotic arm (not shown in FIG. 2) and replaced with an empty build assembly 234 for subsequent fabrication of the next object 211.

As non-exclusive examples, each build platform 234A can define a build area 234C that is rectangular, circular, or polygonal shaped.

In an alternative embodiment, one or more of the build platforms 234A can be moved somewhat like an elevator vertically (along the Z axis) relative to its side wall assembly 234B with a platform mover assembly 234D (illustrated in phantom with a box) during fabrication of the objects 211. Each platform mover assembly 234D can include one or more actuators. Fabrication can begin with the build platform 234A placed near the top of the side wall assembly 234B. The powder supply assembly (not shown in FIG. 2) deposits a thin layer of powder into each build assembly 234 as it is moved (e.g. rotated) below the powder supply assembly. At an appropriate time, the build platform 234A in each build assembly 234 is stepped down by one layer thickness so the next layer of powder may be distributed properly.

In some embodiments, one or more platform mover assemblies 234D can also or alternatively be used to move (e.g. rotate) one or more of the build assemblies 234 relative to the support platform 226A and each other in a platform direction 234E about a platform rotation axis 234F (illustrated with a “+”, e.g. the Z axis). With this design, each build platform 234A can be rotated about two, separate, spaced apart and parallel axes 225A, 234F during the build process.

In one, non-exclusive example, the support platform 226A can be rotated (e.g., at a substantially constant rate) in the moving direction 225 (e.g. counterclockwise), and one or more of the build assemblies 234 can be moved (e.g. rotated) relative to the support platform 226A in the opposite direction 234E (e.g. clockwise) during the printing process. In this example, the rotational speed of the support platform 226A about the support rotational axis 225A can be approximately the same or different from the rotational speed of each build assembly 234 relative to the support platform 226A about the platform rotational axis 234F.

Alternatively, the support platform 226A can be rotated (e.g., at a substantially constant rate) in the moving direction 225 (e.g. counterclockwise), and one or more of the build assemblies 234 can be moved (e.g. rotated) relative to the support platform 226A in the same direction 234E (e.g. counterclockwise) during the printing process.

FIG. 3 is a simplified top illustration of another implementation of a powder bed assembly 314 that can be used in any of the processing machines 10 disclosed herein. In this implementation, the powder bed assembly 314 can be used to make multiple objects (not shown in FIG. 3) substantially simultaneously.

In FIG. 3, the powder bed assembly 314 includes a relatively large support platform 326A, and a plurality of separate, spaced apart, build assemblies 334 that are integrated into the support platform 326A. The number of separate build assemblies 334 can be varied. In FIG. 3, the powder bed assembly 314 includes four separate build assemblies 334. With this design, one or more objects can be made on each build assembly 334. Alternatively, the powder bed assembly 314 can include more than four or fewer than four separate build assemblies 334.

In FIG. 3, each build assembly 334 defines a separate build platform 334A that is selectively lowered like an elevator with a platform mover assembly 334D (illustrated in phantom with a box) into the support platform 326A during the manufacturing process. With this design, the support platform 326A can define the support side wall for each build platform 334A. Fabrication can begin with the build platform 334A placed near the top of the support platform 326A. The powder supply assembly (not shown in FIG. 3) deposits a thin layer of powder onto each build platform 334A as it is moved (e.g. rotated) below the powder supply assembly. At an appropriate time, each build platform 334A is stepped down by one layer thickness so the next layer of powder may be distributed properly. Alternatively, each build platform 334A can be moved in steps that are smaller than the powder layer or moved in a continuous fashion, rather than in discrete steps.

In this Figure, each build platform 334A defines a circular shaped build area 334C that receives the powder (not shown in FIG. 3). Alternatively, for example, each build area 334C can have a different configuration, e.g. rectangular or polygonal shaped.

Additionally, the support platform 326A can be annular shaped and powder bed 326 can include a central, support hub 326D. In this implementation, there can be relative movement (e.g. rotation) between the support platform 326A and the support hub 326D. As a result thereof, one or more of the other components (e.g. the powder supply assembly) of the processing machine (not shown in FIG. 3) can be coupled to the support hub 326D.

In one, non-exclusive embodiment, the support platform 326A with the build assemblies 334 can be rotated like a turntable during printing of the objects in a moving direction 325 about the support rotation axis 325A (illustrated with a “+”) relative to the support hub 326D. With this design, each build platform 334A is rotated about at least one axis 325A during the build process.

In some embodiments, one or more platform mover assemblies 334D can be used to move (e.g. rotate) one or more of the build assemblies 334 relative to the support platform 326A and each other in a platform direction 334E about a platform rotational axis 334F (illustrated with a “+”, e.g. along the Z axis). With this design, each build platform 334A can be rotated about two, separate, spaced apart and parallel axes 325A, 334F during the build process.

In one, non-exclusive example, the support platform 326A can be rotated (e.g., at a substantially constant rate) in the moving direction 325 (e.g. counterclockwise), and one or more of the build assemblies 334 can be moved (e.g. rotated) relative to the support platform 326A in the opposite, platform direction 334E (e.g. clockwise) during the printing process. In this example, the rotational speed of the support platform 326A about the support rotational axis 325A can be approximately the same or different from the rotational speed of each build assembly 334 relative to the support platform 326A about the platform rotational axis 434F.

Alternatively, the support platform 326A and one or more of the build assemblies 334 can be rotated in the same rotational direction during the three dimensional printing operation.

It should be noted that in FIGS. 2 and 3, a separate platform mover assembly 234D, 334D is used for each build assembly 234, 334. Alternatively, one or more of the platform mover assemblies 234D, 334D can be designed to concurrently move more than one build assembly 234,334.

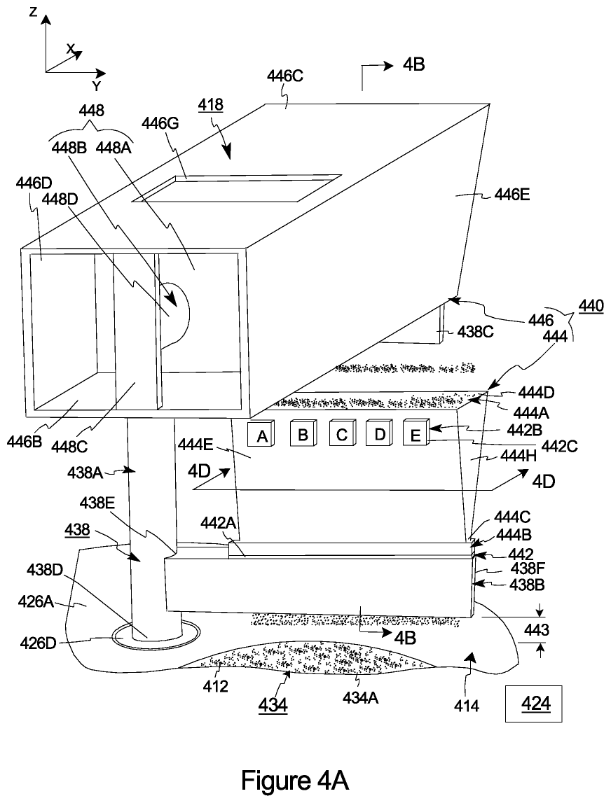

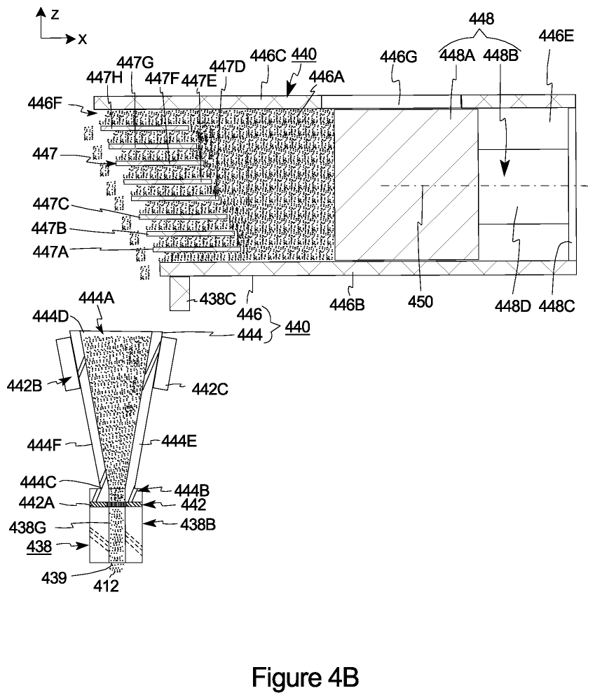

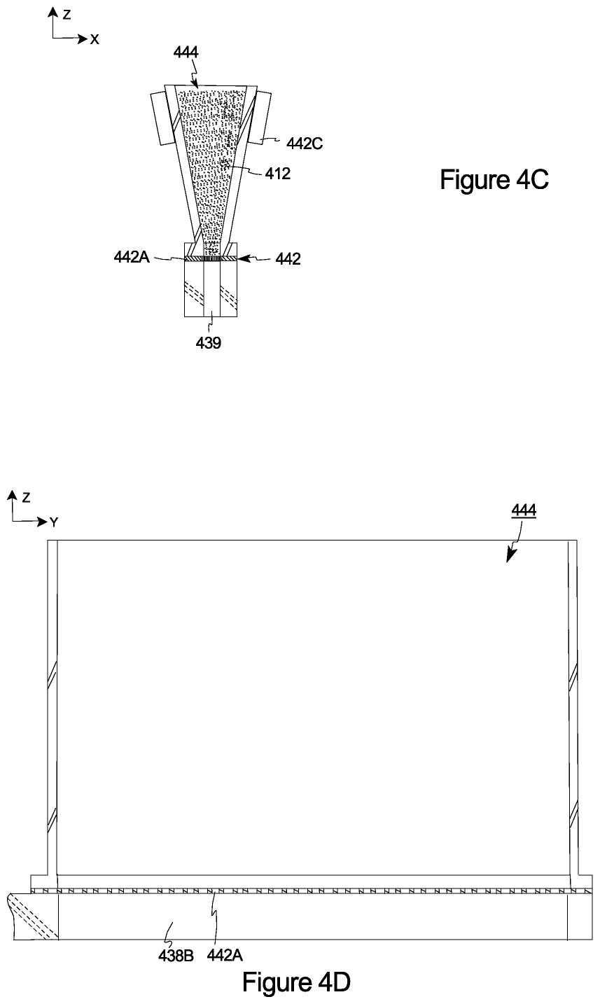

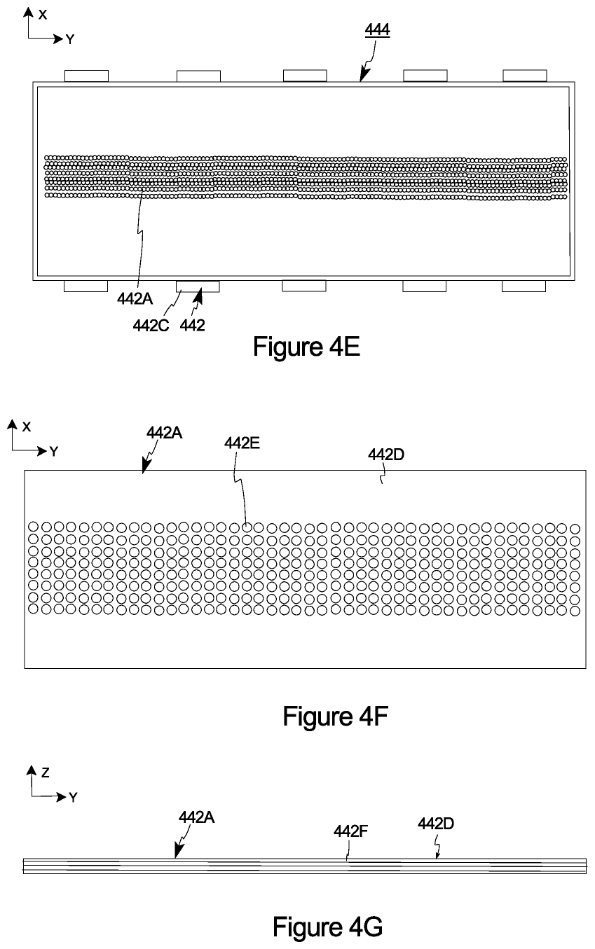

FIG. 4A is a perspective view of a portion of a powder bed assembly 414 including at least one build platform 434A, and a powder supply assembly 418 that can be integrated into the processing machine 10 described above. For example, the powder bed assembly 414 and the powder supply assembly 418 can be designed to have one or more the following movement characteristics while powder 412 is being deposited on the build platform 434A: (i) the build platform 434A is stationary; (ii) the build platform 434A is moved relative to the powder supply assembly 418; (iii) the build platform 434A is moved linearly (along one or more axes) relative to the powder supply assembly 418; (iv) the build platform 434A is rotated (about one or more axes) relative to the powder supply assembly 418; (v) the powder supply assembly 418 is stationary; (vi) the powder supply assembly 418 is moved relative to the build platform 434A; (vii) the powder supply assembly 418 is moved linearly (along one or more axes) relative to the build platform 434A; and/or (viii) the powder supply assembly 418 is rotated (about one or more axes) relative to the build platform 434A. These can be collectively referred to as “Movement Characteristics (i)-(viii)”.

It should be noted that the powder bed assembly 414 and the powder supply assembly 418 can be designed to have any combination of the Movement Characteristics (i)-(viii). Further, the build platform 434A can be circular, rectangular or other suitable shape.

In the implementation illustrated in FIG. 4A, the powder bed assembly 414 is somewhat similar to the implementation illustrated in FIG. 3, and includes a relatively large support platform 426A, a central support hub 426D, and a plurality of separate, spaced apart, build assemblies 434 (only one is illustrated) that are integrated into the support platform 426A. With this design, the support platform 426A with the build assemblies 434 can rotate relative to the support hub 426D, and/or the build assemblies 434 can rotate relative to the support platform 426A.

Further, in FIG. 4A, the powder supply assembly 418 is secured to the support hub 426D, and cantilevers and extends radially over the support platform 426A to selectively deposit the powder 412 (illustrated with small circles) onto the moving build assemblies 434. Alternatively, or additionally, the powder supply assembly 418 could be designed to be moved (e.g. linearly or rotationally) relative to the build assemblies 434. Still alternatively, the powder supply assembly 418 can be retained in another fashion than via the support hub 426D. For example, the powder supply assembly 418 can be coupled to the upper component housing 30 (illustrated in FIG. 1A).

In FIG. 4A, the powder supply assembly 418 is a top-down, gravity driven system that is shown with a circular shaped build platform 434A.

FIG. 4B is a cut-away view of the powder supply assembly 418 taken on line 4B-4B in FIG. 4A.

With reference to FIGS. 4A and 4B, in one implementation, the powder supply assembly 418 includes a supply frame assembly 438, a powder container assembly 440, and a flow control assembly 442 that is controlled by the control system 424 to selectively and accurately deposit the powder 412 onto the build platform(s) 434A. The design of each of these components can be varied to suit the design requirements of the processing machine 10. In FIGS. 4A and 4B, the flow control assembly 442 is illustrated as being recently activated and the powder supply assembly 418 is releasing the powder 412 towards the build platform 434A.

The supply frame assembly 438 supports and couples the powder container assembly 440 and the flow control assembly 442 to the rest of the processing machine 10. The supply frame assembly 438 can fixedly couple these components to the support hub 426D. In one, non-exclusive implementation, the supply frame assembly 438 includes (i) a riser frame 438A that is fixedly coupled to and extends upwardly along the Z axis from the support hub 426D; (ii) a lower transverse frame 438B that is fixedly coupled to and cantilevers radially away from the riser frame 438A; and (iii) an upper transverse frame 438C that is fixedly coupled to and cantilevers radially away from the riser frame 438 spaced apart from the lower transverse frame 438B. It should be noted that any of the frames 438A, 438B, 438C can be referred to as a first frame, a second frame or a third frame.

The riser frame 438A is rigid and includes (i) a riser proximal end 438D that is secured to the support hub 426D, and (ii) a riser distal end (not shown) that is positioned above the support hub 426D. Further, the lower transverse frame 438B is rigid and includes (i) a transverse proximal end 438E that is secured to the riser frame 438A, and (ii) a transverse distal end 438F that extends over an outer perimeter of the build platform 434A. Moreover, the upper transverse frame 438C is rigid and includes (i) a transverse proximal end that is secured to the riser frame 438A, and (ii) a transverse distal end that extends over the build platform 434A. In one, non-exclusive implementation, the riser frame 438A is right cylindrical shaped (e.g. hollow or solid), and each transverse frame 438B, 438C is rectangular beam shaped. However, other shapes and configurations can be utilized.

Additionally, the lower transverse frame 438B can include a frame passageway 438G that allows the powder 412 from the flow control assembly 442 to flow therethrough. For example, the frame passageway 438G can be rectangular shaped. Further, the frame passageway 438G can define the supply outlet 439 of the powder 412 from the powder supply assembly 418. The supply outlet 439 receives the powder 412 from the powder container assembly 440 and the flow control assembly 442.

In one embodiment, the supply outlet 439 is positioned above and spaced apart a separation distance 443 from the build platform(s) 434A or uppermost powder layer on the build platform 434A. The size of the separation distance 443 can vary depending on the environment around the powder supply assembly 418. For example, the separation distance 443 can be larger if operated in a vacuum environment. As a non-exclusive embodiment, the separation distance 443 can be as small as the largest powder particle size. As a non-exclusive example, the separation distance 443 can be between approximately zero to fifty millimeters.

Alternatively, the powder supply assembly 418 can be designed so that the supply outlet 439 is directly adjacent to and/or against the build platform(s) 434A or uppermost powder layer on the build platform 434A.

The powder container assembly 440 retains the powder 412 that is being deposited onto the build platform(s) 434A. In the non-exclusive implementation of FIGS. 4A and 4B, the powder container assembly 440 includes (i) a first container subassembly 444 that retains and deposits the powder 412 onto the build platform(s) 434A; (ii) a second container subassembly 446 that retains and deposits powder 412 into the first container subassembly 444 to refill the first container subassembly 444; and (iii) an actuator system 448 that urges powder 416 from the second container subassembly 446 to fill the first container subassembly 444. The design of these components can be varied pursuant to the teachings provided herein.

In the non-exclusive implementation of FIG. 4A, (i) the first container subassembly 444 is positioned above, coupled to, and supported by the lower transverse frame 438B of the supply frame assembly 438; and (ii) the second container subassembly 446 is positioned above the first container subassembly 444, and the second container subassembly 446 is coupled to and supported by the upper transverse frame 438C of the supply frame assembly 438. However, each container subassembly 444, 446 can be retained in a different fashion.

In one nonexclusive implementation, the first container subassembly 444 defines a first container region 444A that retains the powder 412 prior to distribution onto the build platform 434A, and that is open at the top and the bottom. The first container subassembly 444 can include a container base 444B that couples the first container subassembly 444 to the transverse frame 438B with the flow control assembly 442 positioned therebetween. For example, the first container region 444A and the container base 444B can be integrally formed or secured together during assembly. In this implementation, the opening at the top of the first container region 444A is larger than the opening at its bottom. Further, in this implementation, the first container region 444A is oriented substantially perpendicular to the build platform(s) 434A and is aligned with gravity.

The size and shape of the first container region 444A can be varied to suit the powder 412 supply requirements for the system. In one non-exclusive implementation, the first container region 444A is tapered, rectangular tube shaped (V shaped cross-section) and includes (i) a bottom, container proximal end 444C that is coupled to the container base 444B, and that is an open, rectangular shape; (ii) a top, container distal end 444D that is an open, rectangular tube shaped and positioned above the proximal end 444C; (iii) a front side 444E; (iv) a back side 444F; (v) a left side 444G (illustrated in FIG. 4D); and (vi) a right side 444H. Any of these sides can be referred to as a first, second, third, etc side. The first container region 444A can function as a funnel that uses gravity to urge the powder 412 against the flow control assembly 442.

In one design, the left side 444G and the right side 444H extend substantially parallel to each other; while the front side 444E and a back side 444F taper towards each other moving from the container distal end 444D to the container proximal end 444C. The sides 444E, 444F can be steep (near vertical). As non-exclusive examples, the angle of taper relative to normal (vertical) can be at approximately 0, 0.5, 1, 2, 4, 6, 8, 10, 20, 30 degrees or other angles. The angle of taper can be determined based upon the characteristics (e.g. size) of the powder particles, the material of the powder particles, the amount of powder to be retained in the first container region 444A and other factors. In certain implementations, the first container region 444A comprises two slopes (walls 444E, 444F) getting closer to each other from one end (top 444D) to the other end (bottom 444C) on which the flow controller 442A is provided. Stated in another fashion, the first container region 444A comprises two walls 444E, 444F that slope towards each other from a first end 444D to the second end 444C in which the flow controller 442C is located. An angle between two slopes of the walls 444E, 444F can be determined based upon a type of powder 412.

It should be noted that other shapes and configurations of the first container region 444A can be utilized. For example, the first container region 444A can have a tapering, oval tube shape, or another suitable shape.

The container base 440B can be rectangular tube shaped to allow the powder 412 to flow therethrough.

The control system 424 controls the flow control assembly 442 to selectively and accurately control the flow of the powder 412 from the supply outlet 439 onto the build platform(s) 434A. In one implementation, the flow control assembly 442 includes a flow controller 442A and an activation system 442B. In this implementation, (i) the flow controller 442A can be a flow restrictor such as one or more mesh screen(s) or other porous structure; and (ii) the activation system 442B can include one or more vibration generators 442C that are controlled by the control system 424 to selectively vibrate the first container subassembly 444. Each vibration generator 442C can be a vibration motor.

As provided herein, the plurality of vibration generators 442C are provided on two walls 444E, 444F. Further, in certain implementations, the flow controller 442A is elongated a first direction (e.g. along the Y axis) that crosses the build platform 434A, and the plurality of vibration generators 442C are provided on the walls 444E, 444F along the first direction.

With this design, sufficient vibration of the first container region 444A by the vibration generator(s) 442C causes the powder 412 to flow through the flow controller 442A to the build platform(s) 434A. In contrast, if there is insufficient vibration of the first container region 444A by the vibration generator(s) 442C, there is no flow through the flow controller 442A. Stated in another fashion, the amplitude and frequency of vibration by the vibration generator(s) 442C can control the flow rate of the powder 412 through the flow controller 442A to the build platform(s) 434A. Generally speaking, no vibration results in no flow of the powder 412, while the flow rate of the powder 412 increases as vibration increases. Thus, the vibration generator(s) 442C can be controlled to precisely control the flow rate of powder 412 to the build platform(s) 434A.

The location of the flow controller 442A can be varied. In FIGS. 4A and 4B, the flow controller 442A is located between the first container region 444A and the transverse frame 438B. Alternatively, for example, the flow controller 442A can be located below the transverse frame 438B near the supply outlet 439.

The number and location of the vibration generator(s) 442C can be varied. In the non-exclusive implementation in FIGS. 4A and 4B, the activation system 442B includes (i) five spaced apart vibration generators 442C that are secured to the front side 444E near the top, container distal end 444D; and (ii) five spaced apart vibration generators 442C (only one is visible in FIG. 4B) that are secured to the back side 444F near the container distal end 444D. These vibration generators 442C are located above the flow controller 442A to vibrate the powder 412 in the first container region 444A. Alternatively, the activation system 442B can include more than ten or fewer than ten vibration generators 442C, and/or one or more of the vibration generators 434A located at different positions than illustrated in FIGS. 4A and 4B.

The five vibration generators 442C on each side 444E, 444F can be spaced apart linearly moving left to right. In FIG. 4A, the individual vibration generators 442C on the front side 444E are labeled A-E moving left to right linearly for ease of discussion. With this design, the vibration generators 442C can be independently controlled to control the distribution rate of the powder 412 moving linearly along the power supply assembly 418. This allows for control of the powder distribution radially from near the center to near the edge of the powder bed assembly 414. For example, if more powder 412 is needed near the edge than the center, the vibration generators 442C labelled “D” and “E” can be activated more than the vibration generators 442C labelled “A” and “B”.

With the present design, when it is desired to deposit the powder 412 onto the build platform 434A, the vibration generator(s) 442C is(are) turned ON to start the vibration motion. At this time, the powder 412 will pass from the powder container 440A through the flow controller 442A to deposit the powder 412. In contrast, when it is desired to stop the deposit of the powder 412, the vibration generators 442C are OFF, and the powder 412 will remain inside the powder container 440A.

With the present design, a thin, accurate, even layer of powder 412 can be supplied to the build platform(s) 434A without having to spread the powder 412 (e.g. with a rake) using the top-down vibration activated, powder supply assembly 418 disclosed herein. This powder supply assembly 418 is cost-effective, simple, and reliable method for delivering powder 412. Further, it requires a minimal amount of hardware to achieve even powder layers 412 on the build platform(s) 434A.

It should be noted that another type of flow controller 442A can be utilized to control the flow of powder 412 from the first container region 444A.

The second container subassembly 446 is positioned above the first container subassembly 444 and is used to refill and resupply the first container subassembly 444. In one implementation, the second container subassembly 446 defines a second container region 446A that retains the powder 412 prior to refilling the first container subassembly 444.

The size and shape of the second container region 446A can be varied to suit the powder 412 supply requirements for the system. In one non-exclusive implementation, the second container region 446A is generally rectangular tube shaped, and includes (i) a rectangular shaped bottom wall 446B, (ii) a rectangular shaped top wall 446C that is spaced apart from the bottom wall 446B, (iii) a rectangular shaped left side wall 446D that extends between the bottom wall 446B and the top wall 446C; and (iv) a rectangular shaped right side wall 446E that extends between the bottom wall 446B and the top wall 446C. Any of these walls 446B-446E can be referred to as a first, second, third, etc., wall.

The walls 446B-446E can cooperate to define a refill outlet 446F that is positioned over the open first container region 444A. In this implementation, the actuator system 448 urges the powder 412 from the second container region 446A out the refill outlet 445A, and the powder 412 falls via gravity into the first container region 444A. As illustrated in FIG. 4B, the refill outlet 446F can be a rectangular shaped opening.

Additionally, the second container subassembly 446 can include one or more fins 447 that are positioned in the refill outlet 446F and that extend between the side walls 446D, 446E. For example, the second container subassembly 446 can include a plurality of spaced apart fins 447 (i) that extend transversely across the refill outlet 446F, (ii) that are spaced apart between bottom wall 446B and the top wall 446C; and (iii) that each extend substantially parallel to the bottom wall 446B, the top wall 446C, and the build platform(s) 434A. Further, each successive fin 447 moving from the bottom wall 446B to the top wall 446C can extend farther over the first container subassembly 444.

The number of fins 447 utilized can be varied pursuant to the teachings provided herein. In the non-exclusive implementation of FIG. 4B, the second container subassembly 446 includes eight spaced apart fins 447. Alternatively, the second container subassembly 446 can include more than or fewer than eight spaced apart fins 447. In FIG. 4B, moving from the bottom to the top, the fins 447 can be labeled as a first fin 447A, a second fin 447B, a third fin 447C, a fourth fin 447D, a fifth fin 447E, a sixth fin 447F, a seventh fin 447G, and an eighth fin 447H. In this implementation, (i) the first fin 447A extends farther over the first container subassembly 444 than the bottom wall 446B; (ii) the second fin 447B extends farther over the first container subassembly 444 than the first fin 447A; (iii) the third fin 447C extends farther over the first container subassembly 444 than the second fin 447B; (iv) the fourth fin 447D extends farther over the first container subassembly 444 than the third fin 447C; (v) the fifth fin 447E extends farther over the first container subassembly 444 than the fourth fin 447D; (vi) the sixth fin 447F extends farther over the first container subassembly 444 than the fifth fin 447E; (vii) the seventh fin 447G extends farther over the first container subassembly 444 than the sixth fin 447F; and (viii) the eighth fin 447H extends farther over the first container subassembly 444 than the seventh fin 447G.

With this design, when the actuator system 448 urges the powder 412 from the second container region 446A out the refill outlet 446F, the fins 447 will cause the falling powder 412 to be distributed transversely along the X axis into the first container subassembly 444. This allows the first container subassembly 444 to be filled more accurately, and subsequently allows the first container subassembly 444 to distribute the powder 412 more accurately onto the build platform(s) 434A.

Additionally, in certain implementations, the second container subassembly 446 includes an inlet 446G that allows the second container subassembly 446 to be refilled. For example, the inlet 446G can be an opening in the top wall 446C.

Additionally or alternatively, in certain implementations, to avoid the phenomena known as powder locking or jamming, the top wall 446A and the bottom wall 446B can be designed to not be equidistant everywhere (as shown), but are further apart near the fins 447 to maintain a constant or increasing powder flow area.

In one implementation, the second container region 446A is oriented substantially parallel to the build platform(s) 434A and substantially perpendicular to the first container region 444A. However, other orientations are possible. Further, the container subassemblies 444, 446 in FIGS. 4A and 4B are spaced apart. However, the container subassemblies 444, 446 can be designed to be interconnected in other designs.

The actuator system 448 urges the powder 412 from the second container region 446A out of the refill outlet 446F. In one implementation, the actuator system 448 includes a movable part 448A that is movable in the second container region 446A along a movement axis 450, and a part mover assembly 448B that selectively moves the movable part 448A in the second container region 446. In one non-exclusive example, (i) the movable part 448A can be rectangular box shaped and size to closely fit within the second container region 446, and (ii) the part mover assembly 448B can include a connector beam 448C that extends between the bottom wall 446B and the top wall 446C, and a motor 448D that extends between the connector beam 448C and the movable part 448A.

With this design, the motor 448D can be controlled with the control system 424 to selectively move the movable part 448A in the second container region 446A along the movement axis 450. For example, the motor 448D can move the movable structure 448A as necessary from right to left in FIG. 4B to urge the powder 412 from the second container region 446A to refill the first container region 444A. In FIGS. 4A and 4B, the powder 412 is being urged from the refill outlet 446F. Alternatively, the motor 448D can retract the movable structure 448A (moved from left to right) to allow for refilling of the second container region 446A via the inlet 446G.

In this implementation, the movable part 448A can be moved linearly sideways with the motor 448D (e.g. a linear motor, a fine pitch thread, or other actuator) somewhat similar to a piston relative to the second container region 446A and the walls act like as the piston's cylinder wall 446B-446E.

As illustrated in FIG. 4B, the plurality of fins 447 can be oriented substantially parallel to the movement axis 450. However, other orientations are possible.

Additionally, or alternatively, the powder supply assembly 418 can be used with a powder leveler (not shown) such as a rake, roller, wiper, squeegee, and/or a brush to further improve the flat powder surface.

FIG. 4C is a cut-away view of the first container subassembly 444 similar to FIG. 4B, except in FIG. 4C, the vibration generators 442C are turned off. At this state, no powder 412 is flowing through the flow controller 442A and out the supply outlet 439.

FIG. 4D is a cut-away view taken from line 4D-4D in FIG. 4A of the first container subassembly 444, without the powder. Basically, FIG. 4D illustrates the first container subassembly 444, the flow controller 442A, and a portion of the lower transverse frame 438B.

FIG. 4E is a simplified top view of the first container subassembly 444, without the powder; and the flow controller 442A and the vibration generators 442C of the flow control assembly 442.

FIG. 4F is a top view of one implementation of the flow controller 442A. In this implementation, the flow controller 442A includes a flow structure 442D, and a plurality of flow apertures 442E that extend through the flow structure 442D. In this embodiment, the flow structure 442D is rectangular plate shaped to correspond to the bottom container end 440C (illustrated in FIG. 4B). However, other shapes are possible.

The flow apertures 442E can have a circular, oval, square, polygonal, or other suitable shape. Further, flow apertures 442E can follow a straight or curved path through the flow structure 442D. Moreover, in this implementation, one or more (typically all) of the flow apertures 442E have an aperture size that is larger than a nominal particle size of the powder 412. In alternative, non-exclusive examples, the aperture size is at least approximately 1, 1.25, 1.5, 1.7, 2, 2.5, 3 or 4 times the nominal powder particle size. Further, in alternative, non-exclusive examples, the aperture size is less than approximately 5, 6, 7, 8 or 10 times the nominal powder particle size. Stated in a different fashion, one or more (typically all) of the flow apertures 442E have an aperture cross-sectional area that is larger than a nominal powder particle cross sectional area of the particles of powder 412 (illustrated in FIG. 4A). In alternative, non-exclusive examples, one or more (typically all) of the flow apertures 442E have an aperture cross-sectional area is equal to or larger than the nominal powder cross sectional area of the particles of powder 412 by at least, but not limited to, 1, 2, 3, 5, 10, 20, 40, 50, 60, 70, 80, 90, 100, 150, or 200 percent. Stated differently, as non-exclusive examples, the aperture cross-sectional area can be at least approximately ten, twenty, fifty, one hundred, or one thousand times the nominal powder particle cross-sectional area. Stated in yet another fashion, one or more (typically all) of the flow apertures 442E have an aperture diameter that is larger than a nominal powder particle diameter of the powder particles 412. In alternative, non-exclusive examples, the aperture diameter is at least approximately 1, 1.25, 1.5, 1.75, 2, 3 or 4 times the nominal powder particle diameter. Further, in alternative, non-exclusive examples, the aperture diameter is less than approximately 5, 6, 7, 8 or 10 times the nominal powder particle diameter. However, depending upon the design, other aperture sizes, diameters or cross-sectional areas are possible.

FIG. 4G is a side view the flow structure 442D of the flow controller 442A. In this implementation, the flow structure 442D includes one or more mesh screens 442F. In FIG. 4G, the flow structure 442D includes four mesh screens 442F. Alternatively, it can include more than four or fewer than four mesh screens 442F. In this design, the mesh screens 442F combine to define the plurality of spaced apart flow apertures 442E (illustrated in FIG. 4F).

With reference to FIGS. 4A-4G, in certain implementations, the sizes of flow apertures 442E, the vibration amplitude and/or the vibration directionality of the vibration generator(s) 442C may be adjusted to control the amount of the powder 412 supplied over the build platform 434A. The control system 424 may control the vibration generators 442C based on feedback results from the measurement device 20 (illustrated in FIG. 1A).

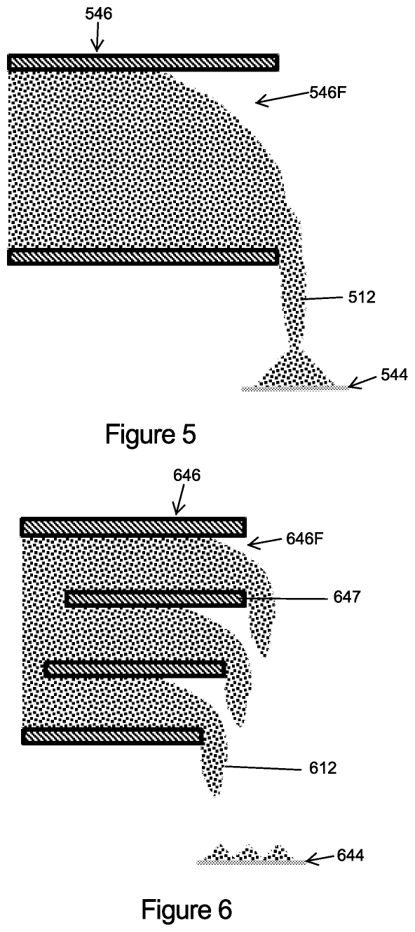

FIG. 5 is a simplified cut-away view of a portion of another implementation of the second container subassembly 546. In this implementation, there are no fins in the refill outlet 546F. As a result thereof, when the powder 512 is urged from the refill outlet 546F, the powder 512 will pile up in the first container subassembly 544 (illustrated as a line for simplicity).

FIG. 6 is a simplified cut-away view of a portion of yet another implementation of the second container subassembly 646. In this implementation, there are two spaced apart fins 647 in the refill outlet 646F. As a result thereof, when the powder 612 is urged from the refill outlet 646F, the powder 612 will be distributed along the first container subassembly 644 (illustrated as a line for simplicity).

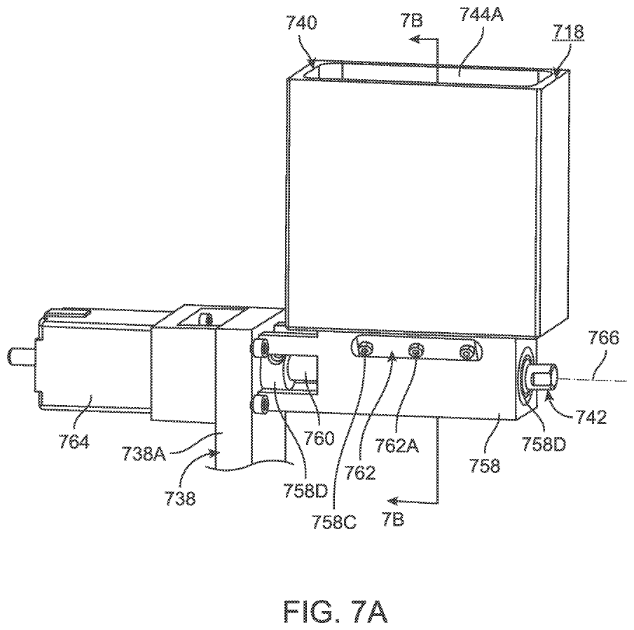

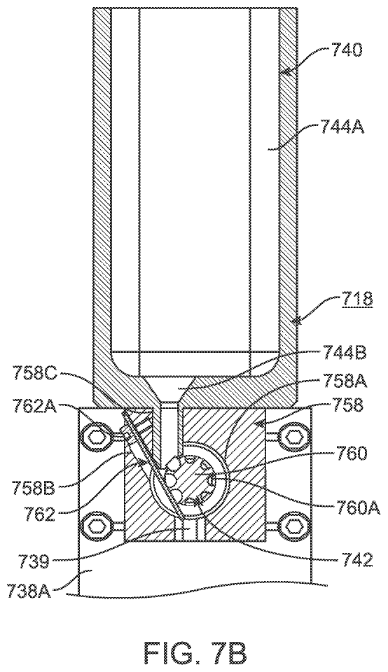

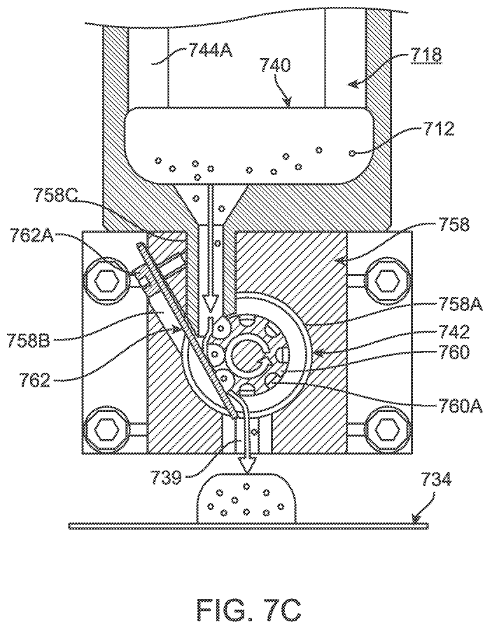

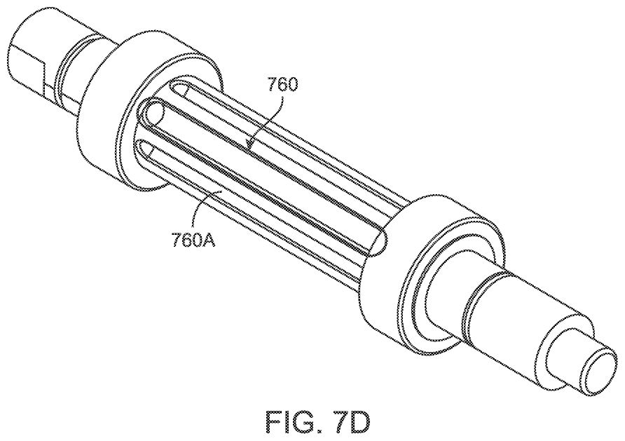

FIG. 7A is a perspective view of another implementation of the powder supply assembly 718 that deposits the powder (not shown in FIG. 7A) under the control of the control system 24 (illustrated in FIG. 1A). This powder supply assembly 718 can be integrated into in any of the processing machines 10 described herein. Further, it should be noted that the powder bed assembly 14 (illustrated in FIG. 1) and the powder supply assembly 718 can be designed to have any combination of the Movement Characteristics (i)-(viii) defined above. Moreover, the powder supply assembly 718 can be used with a build platform (not shown in FIG. 7A) that is circular, rectangular or other suitable shape.

As an overview, the powder supply assembly 718 illustrated in FIG. 7A is a top-down, gravity driven system. The powder supply assembly 718 is practical, relatively simple, and can provide a uniformly distributed layer of powder quickly and efficiently over a relatively large and broad build platform. In one implementation, the powder supply assembly 718 includes a supply frame assembly 738, a powder container assembly 740, and a flow control assembly 742.

The supply frame assembly 738 is rigid and supports the powder container assembly 740, and the flow control assembly 742 above the build platform. In FIG. 7A, the supply frame assembly 738 includes a rigid riser frame 738A. For example, the riser frame 738A can be a rectangular shaped beam that is secured to the support hub 426D (illustrated in FIG. 4A). Alternatively, the riser frame 738A can have a different configuration or can be secured to a different location.

The powder container assembly 740 retains the powder prior to distribution onto the build platform. The powder container assembly 740 can be somewhat the similar to the first container subassembly 444 described above and illustrated in FIG. 4A. In this embodiment, the powder container assembly 740 defines a container region 744A that retains the powder. However, in the non-exclusive implementation of FIG. 7A, the powder container assembly 740 is more, open rectangular box shaped and less tapered than in FIG. 4A. Alternatively, the powder container assembly 740 can be more tapered shaped.

Additionally, and optionally, the powder container assembly 740 can be designed to include the second container region 446A (illustrated in FIG. 4A) that supplies and refills powder to the powder container assembly 740.

FIG. 7B is a cut-away view of the powder supply assembly 718 taken on line 7B-7B in FIG. 7A. In this implementation, the container region 744A can include a funnel region 744B that directs the powder towards the flow control assembly 742. The riser frame 738A is also shown in FIG. 7B.

FIG. 7C is an enlarged portion of powder supply assembly 718 of FIG. 7B with a build platform 734 (illustrated as a line) and the powder 712 illustrated with small circles.

With reference to FIGS. 7A-7C, the flow control assembly 742 is controlled by the control system 24 (illustrated in FIG. 1A) to precisely control the flow of the power 712 from the container region 744A to the supply outlet 739 and the build platform(s) 734. In this implementation, the flow control assembly 742 can include (i) an assembly frame 758; (ii) a flow structure 760 having at least one structure surface feature 760A; (iii) a flow guide 762 that is urged against the flow structure 760; and (iv) a structure mover 764 that moves the flow structure 760 relative to the flow guide 762 to release the powder 712 from the at least one structure surface feature 760A to the supply outlet 739. The design of each of these components can be varied pursuant to the teachings herein.

The assembly frame 758 (i) supports and guides the movement of the flow structure 760 and the flow guide 762; (ii) defines the supply outlet 739; and (iii) supports the powder container assembly 740. In one, non-exclusive implementation, the assembly frame 758 is generally rectangular beam shaped, and is fixedly secured to and cantilevers away from the riser frame 738A. In this implementation, the assembly frame 758 defines (i) a cylindrical shaped frame opening 758A that extends through the assembly frame 758 for receiving the flow structure 760; (ii) a side, guide slot 758B that extends into the frame opening 758A and that receives the flow guide 762; (iii) a top opening 758C for receiving a portion of the power container assembly 740 and the power 712 from the powder container assembly 740; and (iv) a bottom opening that defines the supply outlet 739. In this design, the power container assembly 740 is positioned on the top of the assembly frame 758.

Additionally, the assembly frame 758 can include one or more bearings 758D (e.g. two roller bearings) for guiding the rotation of the flow structure 760.

The flow structure 760 includes one or more structure surface features 760A. FIG. 7D is a perspective view of a non-exclusive implementation of the flow structure 760. In this example, the flow structure 760 can be a rigid, circular shaped shaft that includes a plurality of spaced apart structure surface features 760A such as grooves and/or indentations. In one implementation, each structure surface feature 760A is a longitudinally extending groove in the flow structure 760, and the grooves are spaced apart around the circumference of the flow structure 760. In this design, the flow structure 760 is a mill-shaped shaft.

Each of the structure surface features 760A can have surface cross-sectional areas that are larger than a powder cross-sectional area of a nominal size powder particle 712. As non-exclusive examples, the structure surface features 760A can have a feature size that is much larger than a nominal powder particle size of each of the powder particles. In alternative, non-exclusive examples, the grooves are at least approximately 1, 1.25, 1.5, 1.75, 2, 2.5, 3, 4, 5, 6, or 8 times the nominal powder particle size. Further, in alternative, non-exclusive examples, the grooves are less than approximately 10, 12, 15, or 20 times the nominal powder particle size. Stated in a different fashion, one or more (typically all) of the structure surface features 760A have a feature cross-sectional area that is larger than a nominal powder particle cross sectional area of the individual particles of powder. In alternative, non-exclusive examples, one or more (typically all) of the structure surface features 760A have a feature cross-sectional area that is equal to or larger than the nominal powder cross sectional area of the individual particles of powder by at least, but not limited to, 1, 2, 3, 5, 10, 20, 40, 50, 60, 70, 80, 90, 100, 150, 200, 300, or 400 percent. Stated differently, as non-exclusive examples, the feature cross-sectional area can be at least approximately ten, twenty, fifty, one hundred, one thousand, or two thousand times the nominal powder cross-sectional area. In certain implementations, the structure surface features 760A can have a depth of at least approximately ten, twenty, thirty, forty, fifty, or sixty percent larger than the individual, nominal powder particle size. However, depending upon the design, other feature sizes, feature depths, and/or cross-sectional areas are possible.

Referring back to FIGS. 7A-7C, the flow guide 762 is a resilient member that is urged against the flow structure 760. For example, the flow guide 762 can be a resilient, metal plate positioned in the guide slot 758B and that is secured with one or more fasteners 762A to the assembly frame 758. The flow guide 762 against the flow structure 760 precisely controls the amount of powder 712 in each structure surface feature 760A and the flow through the supply outlet 739.

The structure mover 764 can move (e.g. rotate) the flow structure 760 relative to the flow guide 762 continuously or back and forth about a rotation axis 766. With this design, the powder 712 in the container region 744A moves (e.g. via gravity) into the structure surface features 760A of the flow structure 760, and rotation of the flow structure 760 will result in the powder 712 being evenly dispensed from the supply outlet 739. For example, the structure mover 764 can include an actuator that is controlled by the control system 24. The actuator can be a rotor motor or other type of actuator. In this implementation, the structure mover 764 is fixedly secured to the riser frame 738A.

Additionally, or alternatively, the powder supply assemblies 718, 418, 18 can include one or more adjustable rake(s) (e.g. knife edges), rollers, or other systems for improving the uniformity of the distribution of the powder 12 and remove of any high spots on the build platform.

Additionally, and optionally, the powder container assembly 740 can include one or more vibration generators (not shown) that are controlled by the control system 24 to inhibit bridging, clumping, or clogging of a powder in the powder container assembly 740.

It should be noted that the processing machine 10 can be designed to include multiple powder supply assemblies 418, 718 that are spaced apart, and/or adjacent to each other.

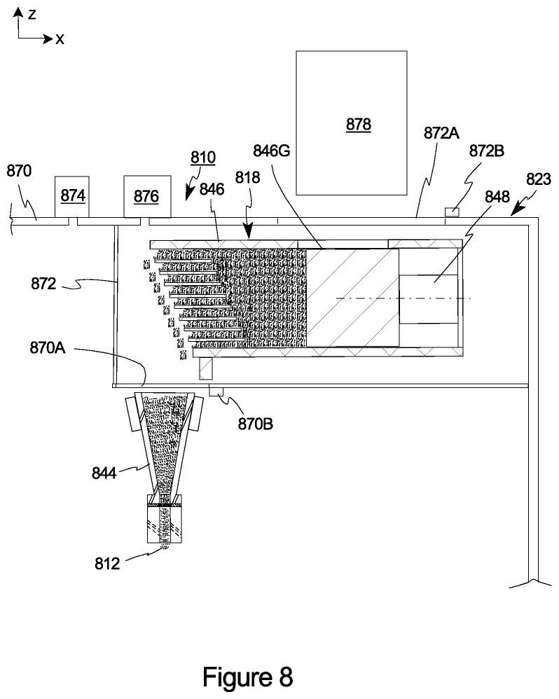

FIG. 8 is a simplified side illustration of a portion of yet another implementation of the processing machine 810 including the powder supply assembly 818 and the environmental chamber assembly 823 (only partly shown). In this implementation, the powder supply assembly 818 is similar to the corresponding component described above and illustrated in FIGS. 4A and 4B. More specifically, in this implementation, the powder supply assembly 818 again includes (i) the first container subassembly 844 that retains and deposits the powder 812 onto the build platform(s) 434A (illustrated in FIG. 4A); (ii) the second container subassembly 846 that retains and deposits powder 812 into the first container subassembly 844 to refill the first container subassembly 844; and (iii) the actuator system 848 that urges powder 812 from the second container subassembly 846 to fill the first container subassembly 844, that are similar to the corresponding components described above.

The environmental chamber assembly 823 provides a controlled environment around one or more of the components of the processing machine 810. The environmental chamber assembly 823 is only partly illustrated in FIG. 8. In the non-exclusive implementation of FIG. 8, the environmental chamber assembly 823 includes (i) a first environmental chamber 870 (only partly shown) that encloses and provides a first controlled environment for the first container subassembly 844; (ii) a second environmental chamber 872 that encloses and provides a second controlled environment for the second container subassembly 846; (iii) a first chamber source 874 (illustrated as a box) that controls the first controlled environment within the first environmental chamber 870; and (iv) a second chamber source 876 (illustrated as a box) that controls the second controlled environment within the second environmental chamber 872. Alternatively, for example, this system can be designed without the second chamber source 876.

It should be noted that in FIG. 8, the first container subassembly 844 is the only component shown in the first environmental chamber 870. However, typically, many of the components of the processing machine 810 will additionally be partly or fully within the controlled environment of the first environmental chamber 870.

As non-exclusive examples, (i) the first chamber source 874 can create a vacuum, or a non-vacuum environment such as inert gas (e.g., nitrogen gas or argon gas) environment in the first environmental chamber 870; and (ii) the second chamber source 876 can control the environment in the second environmental chamber 872 to match that within the first environmental chamber 870.

In FIG. 8, the first environmental chamber 870 can include (i) a first gate 870A that separates the first container subassembly 844 from the second container subassembly 846; and (ii) a first gate mover 870B that selectively moves the first gate 870A between an open configuration and a closed configuration. In this design, when the first gate 870A is in the open configuration, (i) the actuator system 848 can urge the powder 812 from the second container subassembly 844 to refill the first container subassembly 844; and (ii) the second environmental chamber 874 is at the same environment (e.g. pressure) as the first environmental chamber 872. Alternatively, when the first gate 870A is in the closed configuration, (i) the first gate 870A physically separates the second container subassembly 844 from the first container subassembly 844; and (ii) the second environmental chamber 874 can be maintained at a different environment (e.g. pressure) than the first environmental chamber 872. Stated alternatively, (i) when the first gate 870A is open, the first controlled environment is approximately the same as the second controlled environment; and (ii) when the first gate 870A is closed, the second controlled environment can be different from or the same as the first controlled environment.

Moreover, the second environmental chamber 872 can include (i) a second gate 872A that separates the second container subassembly 846 from the surrounding environment; and (ii) a second gate mover 872B that selectively moves the second gate 872A between an open configuration and a closed configuration. In this design, when the second gate 872A is in the open configuration, (i) the second container subassembly 846 is exposed to the surrounding environment (e.g. atmosphere conditions); and (ii) the second container subassembly 846 can be refilled by an auxiliary chamber 878 positioned outside of the environmental control assembly 823 via the inlet 846G to the second container subassembly 846. Alternatively, when the second gate 872A is in the closed configuration, (i) the second gate 872A physically separates the second container subassembly 844 from the surrounding environment; and (ii) the second environmental chamber 874 can be maintained at a different environment (e.g. pressure) than the surrounding environment. Stated alternatively, (i) when the second gate 872A is open, the second controlled environment is approximately the same as the surrounding environment; and (ii) when the second gate 872A is closed, the second controlled environment can be controlled to be the same or different from the first controlled environment.

With the present design, when the first gate 870A is open and the second gate 872A is closed, (i) the first container subassembly 844 and the second container subassembly 846 are maintained at the same environment; and (ii) the second container subassembly 846 can be used to refill the first container subassembly 844. Alternatively, when the first gate 870A is closed and the second gate 872A is open, (i) the first container subassembly 844 can be maintained at the desired controlled environment; (ii) the second container subassembly 846 is exposed to the surrounding environment; and (iii) the auxiliary chamber 878 can be used to fill the second environmental chamber 872.

As a result of this design, the second container subassembly 846 can be refilled without compromising the internal vacuum environment of processing machine 10 is advantageous in maximizing process machine 10 throughput. In this design, the second environmental chamber 872 functions as a load lock chamber having the first and second gates 870A, 872.

It is understood that although a number of different embodiments of the powder supply assembly have been illustrated and described herein, one or more features of any one embodiment can be combined with one or more features of one or more of the other embodiments, provided that such combination satisfies the intent of the present disclosure.

While a number of exemplary aspects and embodiments of the processing machine 10 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A processing machine for building a three-dimensional object from powder, the processing machine comprising:
a build platform;
a powder supply assembly that distributes the powder onto the build platform; the powder supply assembly including (i) a first container region that retains the powder prior to distribution onto the build platform; (ii) a supply outlet positioned over the build platform; (iii) a second container region that retains the powder for refilling the first container region; and (iv) an actuator system that urges powder from the second container region to fill the first container region; and
an energy system that directs an energy beam at a portion of the powder on the build platform to form a portion of the object.

2. The processing machine of claim 1 wherein the powder supply assembly includes a flow control assembly that selectively controls the flow of the powder from the first container region to the supply outlet.

3. The processing machine of claim 1 further comprising a control system that controls the build platform, the powder supply assembly, and the energy system.

4. The processing machine of claim 1 wherein the second container region includes a refill outlet that is positioned above the first container region.

5. The processing machine of claim 4 wherein the actuator system includes a movable part and a part mover assembly that selectively moves the movable part relative to the second container region to urge the powder from the refill outlet.

6. The processing machine of claim 5 wherein the part mover assembly moves the movable part relative to the second container region along a movement axis, and wherein the plurality of fins are oriented substantially parallel to the movement axis.

7. The processing machine of claim 4 wherein the second container region includes a plurality of spaced apart fins that are positioned in the refill outlet.

8. The processing machine of claim 7 wherein the plurality of fins includes a first fin and a second fin that is positioned above the first fin; and wherein the second fin extends farther over the first container region than the first fin.

9. The processing machine of claim 2 wherein the flow control assembly includes a flow structure having a plurality of flow apertures that extend through the flow structure, and wherein at least one of the flow apertures has an aperture size that is larger than a nominal particle size of the powder particles.

10. The processing machine of claim 9 wherein the flow structure allows powder to flow therethrough upon sufficient vibration of the first container region.

11. The processing machine of claim 10 wherein the flow control assembly includes a vibration generator that vibrates the first container region.

12. The processing machine of claim 1 further comprising a mover that rotates at least one of the build platform and the powder supply assembly about a rotation axis while the powder supply assembly deposits the powder onto the build platform.

13. The processing machine of claim 1 further comprising a first environmental chamber that provides a first controlled environment for the first container region, the first environmental chamber including a first gate that separates the first container region from the second container region; wherein the first gate is movable between an open configuration in which the second container region can refill the first container region, and a closed configuration in which the first container region is separated from the second container region.

14. The processing machine of claim 13 further comprising a second environmental chamber that provides a second controlled environment for the second container region, wherein the first gate separates the first environmental chamber from the second environmental chamber.

15. The processing machine of claim 14 wherein the second environmental chamber includes a second gate that is movable between an open configuration in which second container region can be refilled, and a closed configuration in which the container is enclosed, wherein the second gate separates the second environmental chamber from a surrounding environment.

16. A processing machine for building a three-dimensional object from powder, the processing machine comprising:
a build platform;
a powder supply assembly that distributes the powder onto the build platform; the powder supply assembly includes a powder container that retains the powder; a supply outlet positioned over the build platform; and a flow control assembly that selectively controls the flow of the powder from the supply outlet, the flow control assembly including (i) a flow structure having at least one structure surface feature, (ii) a flow guide that is urged against the flow structure, and (iii) a structure mover that moves the flow structure relative to the flow guide to release the powder from the at least one structure surface feature to the supply outlet; and
an energy system that directs an energy beam at a portion of the powder on the build platform to form a portion of the object.

17. The processing machine of claim 16 further comprising a control system that controls the build platform, the powder supply assembly, and the energy system.

18. The processing machine of claim 16 wherein the flow structure is shaft shaped and the flow structure includes a plurality of spaced apart structure surface features.

19. The processing machine of claim 16, wherein the structure mover rotates the flow structure to release the powder to the supply outlet.

20. The processing machine of claim 16 wherein at least one of the structure surface features has a feature size that is larger than a nominal powder particle size of one of the powder particles.

21. The processing machine of claim 16 wherein each of the structure surface features has a feature size that is larger than a nominal powder particle size of one of the powder particles.

22. The processing machine of claim 16 wherein the powder container is positioned so that gravity urges the powder in the powder container against the flow control assembly.

23. The processing machine of claim 16 wherein the flow guide is a resilient plate.

24. The processing machine of claim 16 wherein the flow structure is a mill-shaped shaft.

25. The processing machine of claim 16 further comprising a mover assembly that rotates the build platform relative to the powder supply assembly while the powder supply assembly deposits the powder onto the build platform.

26. The processing machine of claim 16 further comprising a mover that rotates at least one of the build platform and the powder supply assembly about a rotation axis while the powder supply assembly deposits the powder onto the build platform.

27. A method for building a three-dimensional object from powder comprising:
providing a build platform;
distributing powder onto the build platform with a powder supply assembly that includes (i) a first container region that retains the powder prior to distribution onto the build platform; (ii) a supply outlet positioned over the build platform; (iii) a flow control assembly that selectively controls the flow of the powder from the first container region to the supply outlet; (iv) a second container region that retains the powder for refilling the first container region; and (v) an actuator system that urges powder from the second container region to fill the first container region; and
directing an energy beam at a portion of the powder on the build platform to form a portion of the object.

28. A method for building a three-dimensional object from powder comprising:
providing a build platform;
distributing powder onto the build platform with a powder supply assembly that includes a powder container that retains the powder; a supply outlet positioned over the build platform; and a flow control assembly that selectively controls the flow of the powder from the supply outlet, the flow control assembly including (i) a flow structure having at least one structure surface feature, (ii) a flow guide that is urged against the flow structure, and (iii) a structure mover that moves the flow structure relative to the flow guide to release the powder from the at least one structure surface feature to the supply outlet; and
directing an energy beam at a portion of the powder on the build platform to form a portion of the object.
